(19) United States
(12) Patent Application Publication
(10) Pub. No.: US 2020/0012594 A1
(43) Pub. Date: Jan. 9, 2020

(54) SHARED FIFO DEVICE

(71) Applicants: Kabushiki Kaisha Toshiba, Tokyo (JP); Toshiba Electronic Devices & Storage Corporation, Tokyo (JP)

(72) Inventors: Wataru Furuichi, Moriya Ibaraki (JP); Makoto Kanda, Yokohama Kanagawa (JP); Shigeru Itoh, Kawasaki Kanagawa (JP); Hiroshi Nishikawa, Yokohama Kanagawa (JP); Akihiro Kobayashi, Yokohama Kanagawa (JP); Kiyoshige Taga, Kawasaki Kanagawa (JP)

(21) Appl. No.: 16/227,054

(22) Filed: Dec. 20, 2018

(30) Foreign Application Priority Data
Jul. 9, 2018 (JP) 2018-129632

(51) Int. Cl. G06F 12/02; G06F 9/30

(52) U.S. Cl. CPC G06F 12/023; G06F 2212/251; G06F 9/30043

(57) ABSTRACT

According to one embodiment, a shared FIFO device includes a write pointer control circuit, a read pointer control circuit, a write pointer selection circuit, a read pointer selection circuit, a selection circuit, and a memory array. The shared FIFO device performs FIFO access through n transfer routes (where n is an integer of 2 or greater).

### CROSS REFERENCE TO RELATED APPLICATION

This application is based upon and claims the benefit of priority from the prior Japanese Patent Application No. 2018-129632, filed on Jul. 16, 2018, the entire contents of which are incorporated herein by reference.

### FIELD

Embodiments discussed herein are related to a shared FIFO device.

### BACKGROUND

A microcomputer, a microprocessor, and the like are equipped with a first-in, first-out (FIFO) device. A FIFO device has memory with a capacity required by the system specification. To transfer data between devices, each data transfer route needs a FIFO device.

A complicated system requires a large number of data transfer routes and hence a large number of FIFO devices, leading to a problem where the circuit scale of the FIFO devices increases.

### BRIEF DESCRIPTION OF THE DRAWINGS

FIG. 1 is a diagram illustrating a shared FIFO device according to a first embodiment.

FIG. 2 is a flowchart illustrating operation of the shared FIFO device according to the first embodiment.

FIG. 3 is a diagram illustrating Step S1 of the operation of the shared FIFO device.

FIG. 4 is a diagram illustrating Step S2 of the operation of the shared FIFO device.

FIG. 5 is a diagram illustrating Step S3 of the operation of the shared FIFO device.

FIG. 6 is a diagram illustrating Step S4 of the operation of the shared FIFO device.

FIG. 7 is a diagram illustrating Step S5 of the operation of the shared FIFO device.

FIG. 8 is a diagram illustrating Step S6 of the operation of the shared FIFO device.

FIG. 9 is a diagram illustrating Step S7 of the operation of the shared FIFO device.

FIG. 10 is a diagram illustrating Step S8 of the operation of the shared FIFO device.

FIG. 11 is a diagram illustrating Step S9 of the operation of the shared FIFO device.

FIG. 12 is a diagram illustrating Step S10 of the operation of the shared FIFO device.

FIG. 13 is a diagram illustrating Step S11 of the operation of the shared FIFO device.

FIG. 14 is a diagram illustrating Step S12 of the operation of the shared FIFO device.

FIG. 15 is a diagram illustrating Step S13 of the operation of the shared FIFO device.

FIG. 16 is a diagram illustrating Step S14 of the operation of the shared FIFO device.

FIG. 17 is a diagram illustrating a shared FIFO device according to a second embodiment.

FIG. 18 is a flowchart illustrating operation of the shared FIFO device according to the second embodiment.

FIG. 19 is a diagram illustrating Step S21 of the operation shared FIFO device.

FIG. 20 is a diagram illustrating Step S22 of the operation of the shared FIFO device.

FIG. 21 is a diagram illustrating Step S23 of the operation of the shared FIFO device.

FIG. 22 is a diagram illustrating Step S24 of the operation of the shared FIFO device.

FIG. 23 is a diagram illustrating Step S25 of the operation of the shared FIFO device.

FIG. 24 is a diagram illustrating Step S26 of the operation of the shared FIFO device.

FIG. 25 is a diagram illustrating Step S27 of the operation of the shared FIFO device.

FIG. 26 is a diagram illustrating Step S28 of the operation of the shared FIFO device.

FIG. 27 is a diagram illustrating Step S29 of the operation of the shared FIFO device.

FIG. 28 is a diagram illustrating Step S30 of the operation of the shared FIFO device.

FIG. 29 is a diagram illustrating Step S31 of the operation of the shared FIFO device.

FIG. 30 is a diagram illustrating Step S32 of the operation of the shared FIFO device.

FIG. 31 is a diagram illustrating Step S33 of the operation of the shared FIFO device.

FIG. 32 is a diagram illustrating Step S34 of the operation of the shared FIFO device.,

### DETAILED DESCRIPTION

According to one embodiment, a shared FIFO device performs FIFO access through n transfer routes (where n is an integer of 2 or greater) and includes a write pointer control circuit, a read pointer control circuit, a write pointer selection circuit, a read pointer selection circuit, a selection circuit, and a memory array. The write pointer control circuit selects one of n write pointers based on a write pointer update request, the write pointers being arranged independently for the respective transfer routes, and instructs the selected write pointer to update information held by the write pointer. The read pointer control circuit selects one of n read pointers based on a read pointer update request, the read pointers being arranged independently for the respective transfer routes, and instructs the selected read pointer to update information held by the read pointer. The write pointer selection circuit selects the information in one of the n write pointers based on a route write select instruction. The read pointer selection circuit selects the information in one of the n read pointers based on a route read select instruction. The selection circuit selects a selection result from the write pointer selection circuit based on a write select instruction, and selects a selection result from the read pointer selection circuit based on a read select instruction. The memory array has m FIFO buffer memories (where m is an integer of 2 or greater), each including a next-entry-number memory area and a data memory area to be accessed based on write pointer information and read pointer information.

More embodiments will be described below with reference to the drawings. Throughout the drawings, the same reference numerals denote the same or like portions.

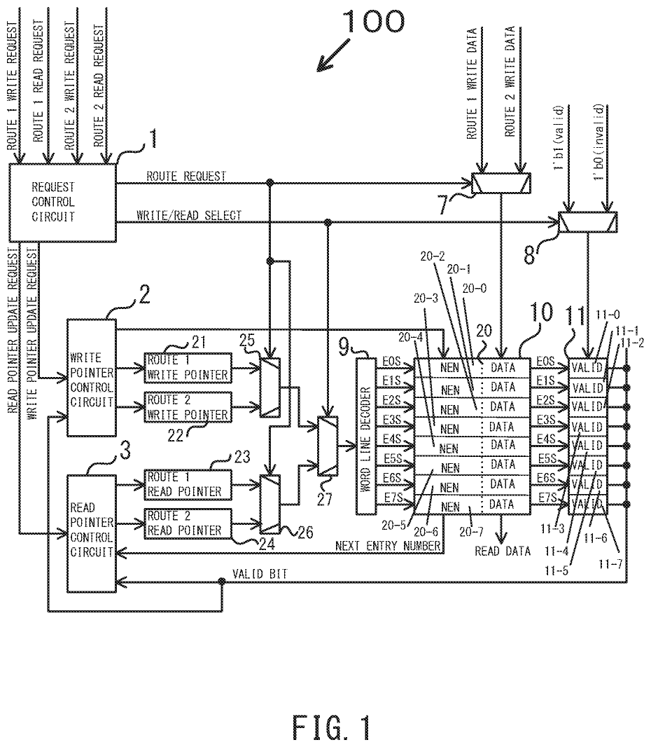

A shared FIFO device according to a first embodiment is described with reference to some of the drawings. FIG. 1 is a diagram illustrating the shared FIFO device.

The shared FIFO device of the first embodiment includes two write pointers, two read pointers, a write pointer selection circuit, a read pointer selection circuit, and a selection circuit to select a write operation or a read operation, and has two data transfer routes to decrease the circuit scale.

As illustrated in FIG. 1, a shared FIFO device 100 includes a request control circuit 1, a write pointer control circuit 2, a read pointer control circuit 3, a data selection circuit 7, a validity value selection circuit 8, a word line decoder 9, a memory array 10, a validity bit section 11, a write pointer 21, a write pointer 22, a read pointer 23, a read pointer 24, a write pointer selection circuit 25, a read pointer selection circuit 26, and a selection circuit 27.

The shared FIFO device 100 is a FIFO device that includes two data transfer routes and is capable of using them in a shared manner. The shared FIFO device 100 is applied to a system with two synchronized data transfer routes (e.g., a system with a microcomputer, a microprocessor, or the like).

The shared FIFO device 100 is used in, for example, devices required to consume low power and have high functionality such as a wearable device, a healthcare device, an industrial safety device, and a humanoid robot.

The request control circuit 1 receives a route 1 write request, a route 1 read request, a route 2 write request, and a route 2 read request. The request control circuit 1 transmits a route request to the data selection. circuit 7, the write pointer selection circuit 25, and the read pointer selection. circuit 26. The request control circuit 1 transmits a write or read select instruction to the validity value selection circuit 8 and the selection circuit 27. The request control circuit 1 transmits a write pointer update request to the write pointer control circuit 2. The request control circuit 1 transmits a read pointer update request to the read pointer control circuit 3.

The data selection circuit 7 receives route 1 write data and route 2 write data, selects the route 1 write data or the route 2 write data based on the route request from the request control circuit 1, and outputs the selected data to a corresponding data memory area DATA of the memory array 10. The route 1 write data is data used for, for example, serial input/output (SIO) mode, whereas the route 2 write data is data used for, for example, a universal asynchronous receiver-transmitter (UART).

The validity value selection circuit 8 receives a validity value which is valid and a validity value 1′b0 which is invalid, selects one of the validity value 1′b1 and the validity value 1′b0 based on the write or read select instruction, and outputs the selected validity value to the validity bit section 11.

The write pointer control circuit 2 receives a write pointer update request from the request control circuit 1. Based on the write pointer update request from the request control circuit 1, the write pointer control circuit 2 instructs the write pointer 21 (a first write pointer) or the write pointer 22 (a second write pointer) to update the write point. Based on the write pointer update request from the request control circuit 1, the write pointer control circuit 2 specifies a next-entry-number memory area NEN in the memory array 10.

The read pointer control circuit 3 receives a read pointer update request from the request control circuit 1. Based on the read pointer update request from the request control circuit 1, the read pointer control circuit 3 instructs the read pointer 23 (a first read pointer) or the read pointer 24 (a second read pointer) to update the read point.

Based on the write pointer control circuit 2, the write pointer 21 updates the value held in itself. Based on the write pointer control circuit 2, the write pointer 22 updates the value held in itself Based on the read pointer control circuit 3, the read pointer 23 updates the value held in itself Based on the read pointer control circuit 3, the read pointer 24 updates the value held in itself.

The write pointer selection circuit 25 receives the information held by the write pointer 21 and the information held by the write pointer 22, and based on the route request from the request control circuit 1, selects the information held by the write pointer 21 or the information held by the write pointer 22.

The read pointer selection circuit 26 receives the information held by the read pointer 23 and the information held by the read pointer 24, and based on the route request from the request control circuit 1, selects the information held by the read pointer 23 or the information held by the read pointer 24.

The selection circuit 27 receives a selection result from the write pointer selection circuit 25 and a selection result from the read pointer selection circuit 26, and based on the write or read select instruction from the request control circuit 1, selects the selection result from the write pointer selection circuit 25 or the selection result from the read pointer selection circuit 26.

Although a multiplexer is used as the data selection circuit 7, the validity value selection circuit 8, the write pointer selection circuit 25, the read pointer selection circuit 26, and the selection circuit 27 herein, a selector or the like may be used instead.

The word line decoder 9 is provided between the selection circuit 27 and the memory array 10. The word line decoder 9 receives a selection result from the selection circuit 27, performs decoding processing on the selection result, and notifies the memory array 10 of a result of the decoding processing as one of entry requests E0S to E7S. Specifically the word line decoder 9 outputs a selection signal to a word line of the memory array 10 to which to write or from which to read data.

The memory array 10 includes in buffers 20 (where m is an integer of 2 or greater) each constituted by the next-entry-number memory area NEN and the data memory area DATA. The buffers 20 are FIFO buffer memories. Here, the memory array 10 includes eight buffers 20-0 to 20-7.

Upon receipt of an instruction from the write pointer control circuit 2 and a decoding processing result from the word line decoder 9, the next-entry-number memory area NEN updates the entry number of the corresponding word line. Upon receipt of a selection result from the data selection circuit 7 and a decoding processing result from the word line decoder 9, the data memory area DATA updates data in the data memory area DATA on the corresponding word line.

The memory array 10 outputs the information in the data memory area DATA on the specified line. The memory array 10 outputs the information in the next-entry-number memory area NEN in which the next entry number is stored, to the read pointer control circuit 3.

The validity bit section 11 includes m validity bits (where in is an. integer of 2 or greater). Here, the validity bit section 11 includes eight validity bits 11-0 to 11-7. Based on a selection result from the validity value selection circuit 8 and the updated information in the data memory area DATA of the memory array 10, the validity bit section 11 updates the information in the corresponding validity bit. The validity bit section 11 outputs valid/invalid information for a corresponding one of the entry requests E0S to E7S to the write pointer control circuit 2 and the read pointer control circuit 3.

Here, read access to the buffers 20 is performed using a pre-updated pointer value. Write access to the next-entry-number memory area NEN is made based on pre-updated pointer values in the write pointer 21 and the write pointer 22, and write access to the buffers 20 is made based on updated pointer values in the write pointer 21 and the write pointer 22. The updated value in the read pointer 23 or the read pointer 24 is a copy of the value in the next-entry-number memory area NEN of the entry being read.

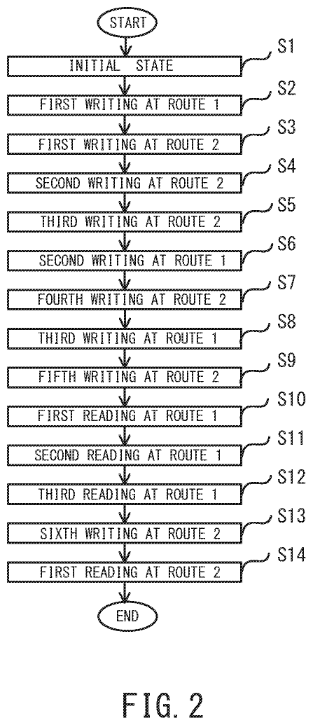

Next, operation of the shared FIFO device is described with reference to FIGS. 2 to 16. FIG. 2 is a flowchart illustrating the operation of the shared FIFO device.

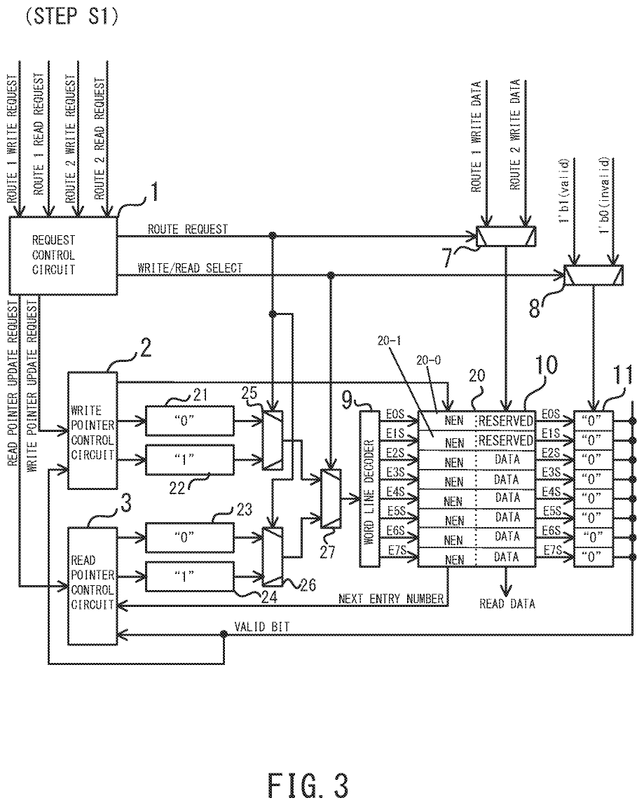

As illustrated in FIG. 2, the shared FIFO device 100 of the first embodiment performs a write operation at the route 1, a write operation at the route 2, a read operation at the route 1, and a read operation at the route 2. Steps of the operation of the shared FIFO device are described in detail. using FIGS. 3 to 16.

As illustrated in FIG. 3, in the initial state, data in the write pointer 21 is set to “0”, data in the write pointer 22 is set to “1”, data in the read. pointer 23 is set to “0”, and data in the read pointer 24 is set to “1”. The data memory area DATA of the buffer 20-0 and the data memory area DATA of the buffer 20-1 are set to the reserved state (Step S1).

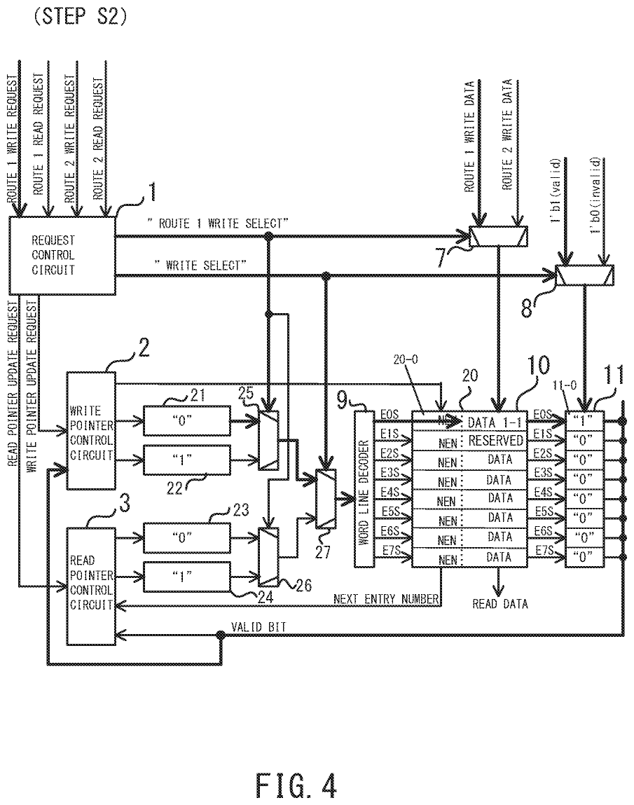

As illustrated in FIG. 4, for the first write operation at the route 1, the request control circuit 1 receives a route 1 write request. The write pointer selection circuit 25 receives a route 1 write select instruction outputted from the request control circuit 1. Based on the route 1 write select instruction from the request control circuit 1, the write pointer selection circuit 25 selects “0”, which is the value of the write pointer 21. The selection circuit 27 receives a write select instruction outputted from the request control circuit 1. Based on the write select instruction from the request control circuit 1, the selection circuit 27 selects the select result (“0”) from the write pointer selection circuit 25.

As a result, the data memory area DATA of the buffer 20-0 on the first word line is selected. Route 1 write data outputted from the data selection circuit 7 is written to the data memory area DATA of the buffer 20-0 (the data is indicated as DATA 1-1). Data in the validity bit 11-0 is set to valid information “1” based on 1′b1 outputted from the validity value selection circuit 8 and the write result from the data memory area DATA of the buffer 20-0. The valid information is transmitted to the write pointer control circuit 2 (Step S2).

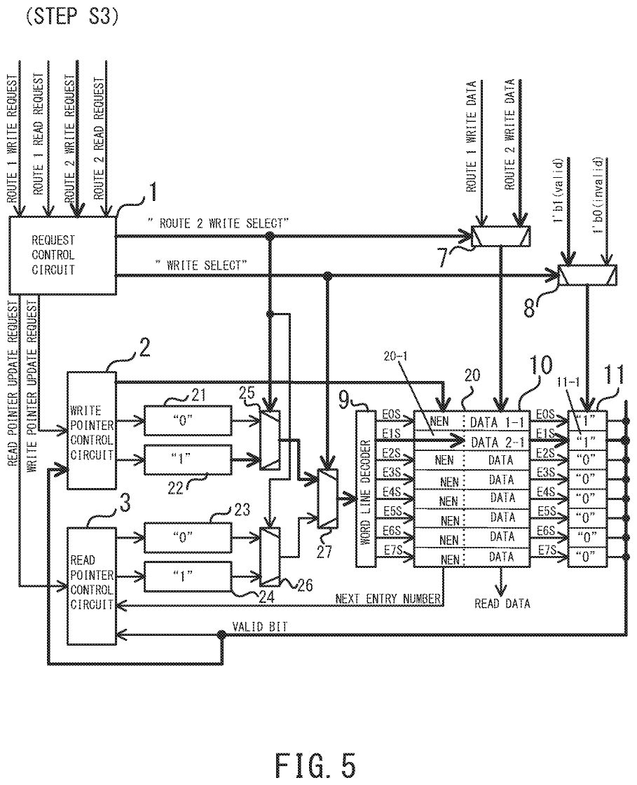

As illustrated in FIG. 5, for the first write operation at the route 2, the request control circuit 1 receives a route 2 write request. The write pointer selection circuit 25 receives a route 2 write select instruction outputted from the request control circuit 1. Based on the route 2 write select instruction. from the request control circuit 1, the write pointer selection circuit 25 selects “1” of the write pointer 21. The selection circuit 27 receives a write select instruction outputted from the request control circuit 1. Based on the write select instruction from the request control circuit 1, the selection circuit 27 selects the select result (“1”) from the write pointer selection circuit 25.

The memory array 10 receives a decoding processing result from the word line decoder 9 and an instruction from the write pointer control circuit 2. As a result, the data memory area DATA of the buffer 20-1 on the next word line is selected. Route 2 write data outputted from the data selection circuit 7 is written to the data memory area DATA of the buffer 20-1 (the data is indicated as DATA 2-1). Data in the validity bit 11-1 is set to valid information “1” based on 1′b1 outputted from the validity value selection circuit 8 and the write result from the data memory area DATA of the buffer 20-1. The valid information is transmitted to the write pointer control circuit 2 (Step S3).

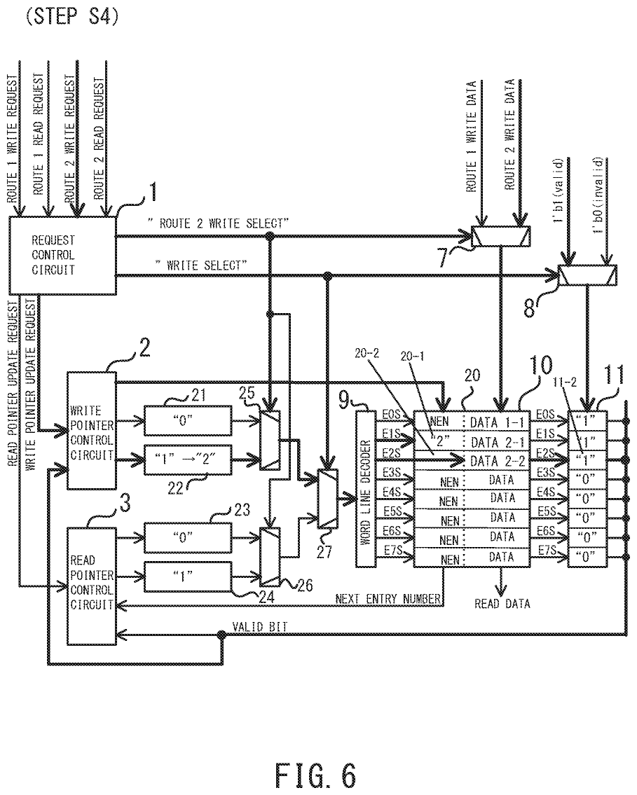

As illustrated in FIG. 6, for the second write operation at the route 2, the request control circuit 1 receives a route 2 write request and transmits a write pointer update request to the write pointer control circuit 2.

Based on the write pointer update request from the request control circuit 1, the write pointer control circuit 2 updates the data held by the write pointer 22 from “1” to “2”. The write pointer selection circuit 25 receives a route 2 write select instruction outputted from the request control circuit 1. Based on the route 2 write select instruction from the request control circuit 1, the write pointer selection circuit 25 selects “2” of the write pointer 22. The selection circuit 27 receives a write select instruction. outputted from the request control circuit 1. Based on the write select instruction from the request control circuit 1, the selection circuit 27 selects the selection result (“2”) from the write pointer selection circuit 25.

The memory array 10 receives a decoding processing result from the word line decoder 9 and an instruction from the write pointer control circuit 2. As a result, data in the next-entry-number memory area NEN of the buffer 20-1 is set to “2”. The data memory area DATA of the buffer 20-2 on the next word line is selected. Route 2 write data outputted from the data selection circuit 7 is written to the data memory area DATA of the buffer 20-2 (the data is indicated as DATA 2-2). Data in the validity bit 11-2 is set to valid information “1” based on 1′b1. outputted from the validity value selection circuit 8 and the write result from the data memory area DATA of the buffer 20-2. The valid information is transmitted to the write pointer control circuit 2 (Step S4).

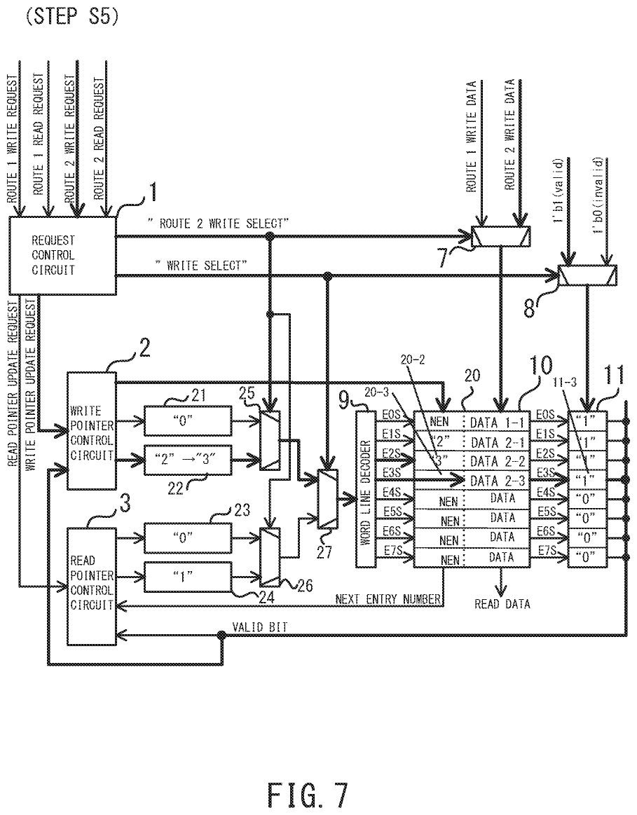

As illustrated in FIG. 7, for the third write operation at the route 2, the request control circuit 1 receives a route 2 write request and transmits a write pointer update request to the write pointer control circuit 2.

Based on the write pointer update request from the request control circuit 1, the write pointer control circuit 2 updates the data held by the write pointer 22 from “2” to “3”. The write pointer selection circuit 25 receives a route 2 write select instruction outputted from the request control circuit 1. Based on the route 2 write select instruction from the request control circuit 1, the write pointer selection circuit 25 selects “3” of the write pointer 22. The selection circuit 27 receives a write select instruction outputted from the request control circuit 1. Based on the write select instruction from the request control circuit 1, the selection circuit 27 selects the selection result (“3”) from the write pointer selection circuit 25.

The memory array 10 receives a decoding processing result from the word line decoder 9 and an instruction from the write pointer control circuit 2. As a result, data in the next-entry-number memory area NEN of the buffer 20-2 is set to “3”. The data memory area DATA of the buffer 20-3 on the next word line is selected. Route 2 write data outputted from the data selection circuit 7 is written to the data memory area DATA of the buffer 20-3 (the data is indicated as DATA 2-3). Data in the validity bit 11-3 is set to valid information “1” based on 1′b1 outputted from the validity value selection circuit 8 and the write result from the data memory area DATA of the buffer 20-3. The valid information is transmitted to the write pointer control circuit 2 (Step S5).

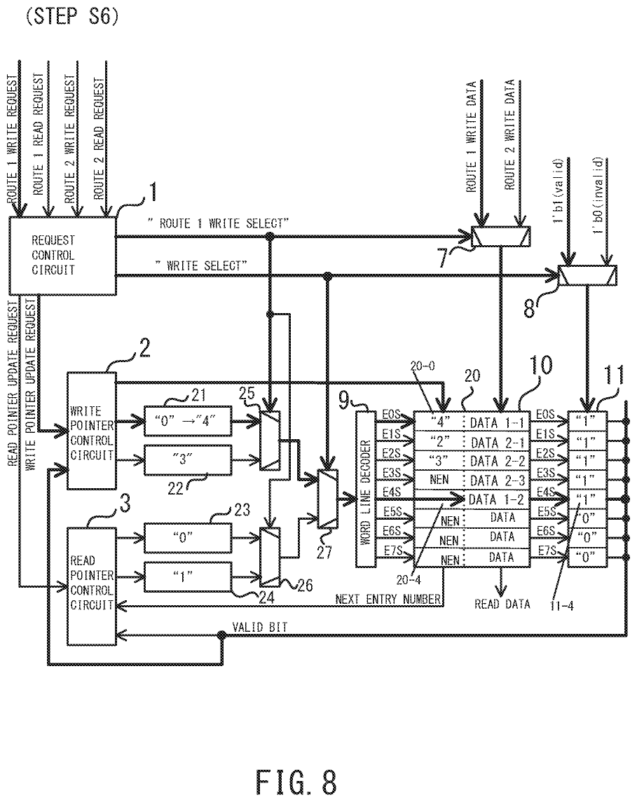

As illustrated in FIG. 8, for the second write operation at the route 1, the request control circuit 1 receives a route 1 write request and transmits a write pointer update request to the write pointer control circuit 2.

Based on the write pointer update request from the request control circuit 1, the write pointer control circuit 2 updates the data held by the write pointer 21 from “0” to “4”. The write pointer selection circuit 25 receives a route 1 write select instruction outputted from the request control circuit 1. Based on the route 1 write select instruction from the request control circuit 1, the write pointer selection circuit 25 selects “4” of the write pointer 21. The selection circuit 27 receives a write select instruction outputted from the request control circuit 1. Based on the write select instruction from the request control circuit 1, the selection circuit 27 selects the selection result (“4”) from the write pointer selection circuit 25.

The memory array 10 receives a decoding processing result from the word line decoder 9 and an instruction from the write pointer control circuit 2. As a result, the data in the next-entry-number memory area NEN of the buffer 20-0 is set to “4”. The data memory area DATA of the buffer 20-4 on the next word line is selected. Route 1 write data outputted from the data selection circuit 7 is written to the data memory area DATA of the buffer 20-4 (the data is indicated as DATA 1-2). Data in the validity bit 11-4 is set to valid information “1” based on 1′b1 outputted from the validity value selection circuit 8 and the write result from the data memory area DATA of the buffer 20-4. The valid information is transmitted to the write pointer control circuit 2 (Step S6).

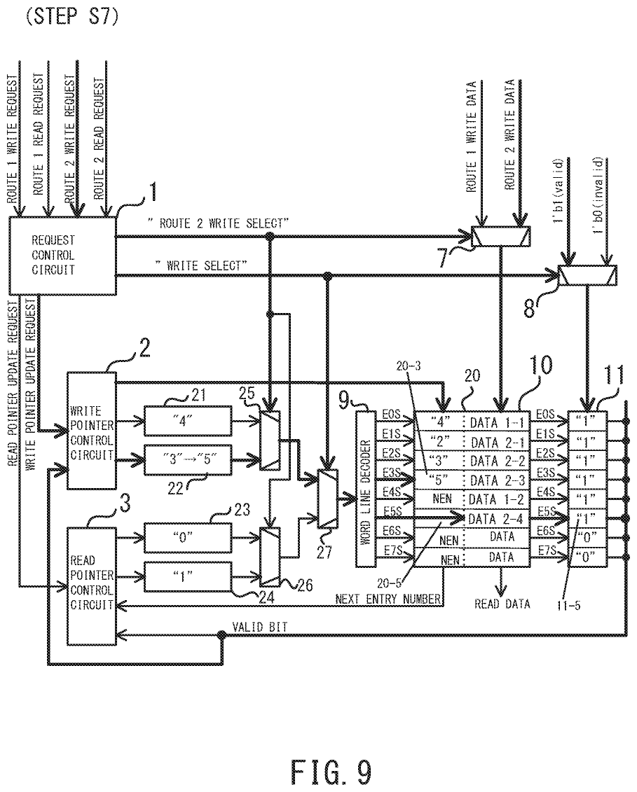

As illustrated in FIG. 9, for the fourth write operation at the route 2, the request control circuit 1 receives a route 2 write request and transmits a write pointer update request to the write pointer control circuit 2.

Based on the write pointer update request from the request control circuit 1, the write pointer control circuit 2 updates the data held by the write pointer 22 from “3” to “5”. The write pointer selection circuit 25 receives a route 2 write select instruction outputted from the request control circuit 1. Based on the route 2 write select instruction from the request control circuit 1, the write pointer selection circuit 25 selects “5” of the write pointer 22. The selection circuit 27 receives a write select instruction outputted from the request control circuit 1. Based on the write select instruction from the request control circuit 1, the selection circuit 27 selects the selection result (“5”) from the write pointer selection circuit 25.

The memory array 10 receives a decoding processing result from the word line decoder 9 and an instruction from the write pointer control circuit 2. As a result, the data in the next-entry-number memory area NEN of the buffer 20-3 is set to “5”. The data memory area DATA of the buffer 20-5 on the next word line is selected. Route 2 write data outputted from the data selection circuit 7 is written to the data memory area DATA of the buffer 20-5 (the data is indicated as DATA 2-4). Data in the validity bit 11-5 is set to valid information “1” based on 1′b1 outputted from the validity value selection circuit 8 and the write result from the data memory area DATA of the buffer 20-5. The valid information is transmitted to the write pointer control circuit 2 (Step S7).

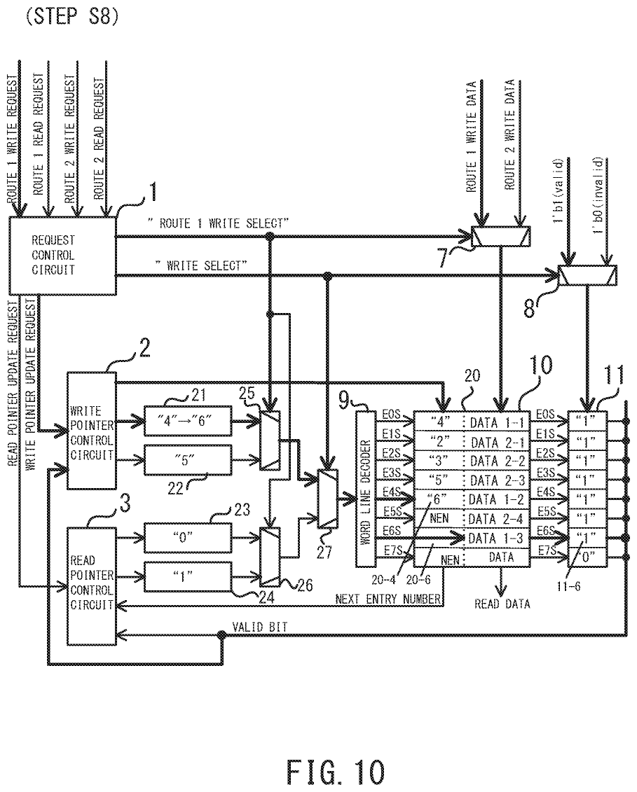

As illustrated in FIG. 10, for the third write operation at the route 1, the request control circuit 1 receives a route 1 write request and transmits a write pointer update request to the write pointer control circuit 2.

Based on the write pointer update request from the request control circuit 1, the write pointer control circuit 2 updates the data held by the write pointer 21 from “4” to “6”. The write pointer selection circuit 25 receives a route 1 write select instruction outputted from the request control circuit 1. Based on the route 1 write select instruction from the request control circuit 1, the write pointer selection circuit 25 selects “6” of the write pointer 21. The selection circuit 27 receives a write select instruction outputted from the request control circuit 1. Based on the write select instruction from the request control circuit 1, the selection circuit 27 selects the selection result (“6”) from the write pointer selection circuit 25.

The memory array 10 receives a decoding processing result from the word line decoder 9 and an instruction of the write pointer control circuit 2. As a result, the data in the next-entry-number memory area NEN of the buffer 20-4 is set to “6”. The data memory area DATA of the buffer 20-6 on the next word line is selected. Route 1 write data outputted from the data selection circuit 7 is written to the data memory area DATA of the buffer 20-6 (the data is indicated as DATA 1-3). Data in the validity bit 11-6 is set to valid information “1” based on 1′b1 outputted from the validity value selection circuit 8 and the write result from the data memory area DATA of the buffer 20-6. The valid information is transmitted to the write pointer control circuit 2 (Step S8).

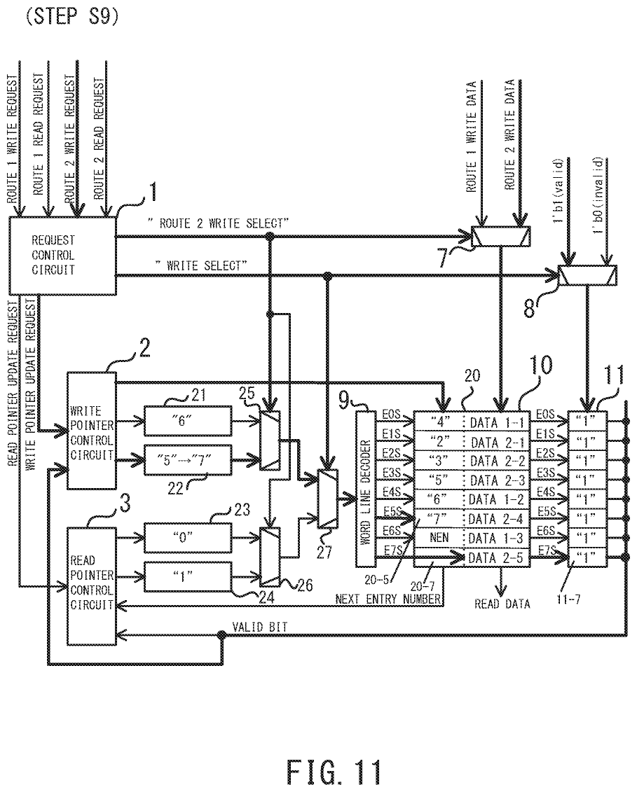

As illustrated in FIG. 11, for the fifth write operation at the route 2, the request control circuit 1 receives a route 2 write request and transmits a write pointer update request to the write pointer control circuit 2.

Based on the write pointer update request from the request control circuit 1, the write pointer control circuit 2 updates the data held by the write pointer 22 from “5” to “7”. The write pointer selection circuit 25 receives a route 2 write select instruction outputted from the request control circuit 1. Based on the route 2 write select instruction from the request control circuit 1, the write pointer selection circuit 25 selects “7” of the write pointer 22. The selection circuit 27 receives a write select instruction outputted from the request control circuit 1. Based on the write select instruction from the request control circuit 1, the selection circuit 27 selects the selection result (“7”) from the write pointer selection circuit 25.

The memory array 10 receives a decoding processing result from the word line decoder 9 and an instruction from the write pointer control circuit 2. As a result, the data in the next-entry-number memory area NEN of the buffer 20-5 is set to “7”. The data memory area DATA of the buffer 20-7 on the next word line is selected. Route 2 write data outputted from the data selection circuit 7 is written to the data memory area DATA of the buffer 20-7 (the data is indicated as DATA 2-5). Data in the validity bit 11-7 is set to valid information “1” based on 1′b1 outputted from the validity value selection circuit 8 and the write result from the data memory area DATA of the buffer 20-7. The valid information is transmitted to the write pointer control circuit 2 (Step S9).

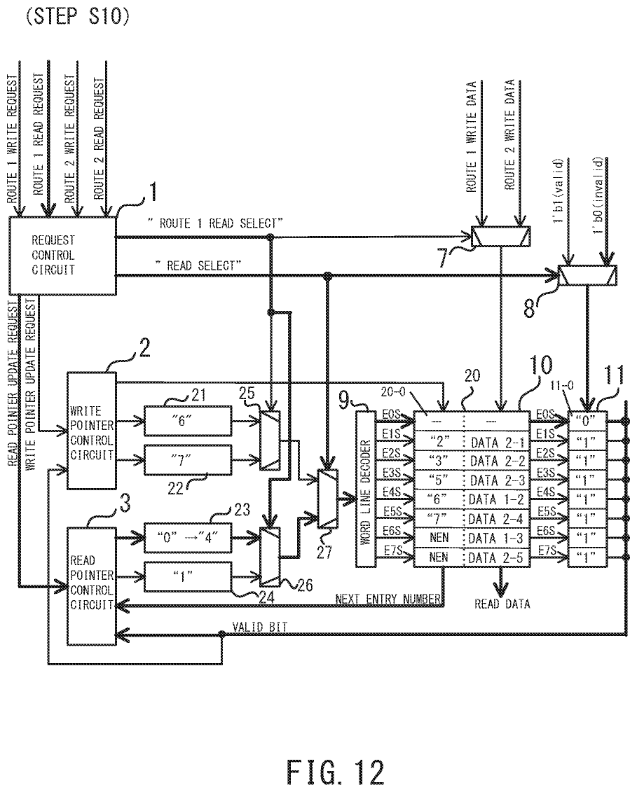

As illustrated in FIG. 12, for the first read operation at the route 1, the request control circuit 1 receives a route 1 read request and transmits a read pointer update request to the read pointer control circuit 3.

Based on the read pointer update request from the request control circuit 1, the read pointer control circuit 3 updates the data held by the read pointer 23 from “0” to “4”. The read pointer selection circuit 26 receives a route 1 read select instruction outputted from the request control circuit 1. Based on the route 1 read select instruction from the request control circuit 1, the read pointer selection circuit 26 selects “0” of the read pointer 23. The selection circuit 27 receives a read select instruction outputted from the request control circuit 1. Based on the read select instruction from the request control circuit 1, the selection circuit 27 selects the selection result (“0”) from the read pointer selection circuit 26.

According to the value in the read pointer 23, the data (DATA 1-1) stored in the data memory area DATA of the buffer 20-0 is read and outputted to the outside. The data in the next-entry-number memory area NEN of the buffer 20-0 is read and transmitted to the read pointer control circuit 3. The data stored in the data memory area DATA of the buffer 20-0 and the data in the next-entry-number memory area NEN of the buffer 20-0 are updated. The validity bit 11-0 is changed from the valid information “1” to invalid information “0”, and the data is cleared. Information indicative of the clearing concerning the validity bit 11-0 is transmitted to the read. pointer control circuit 3 (Step S10).

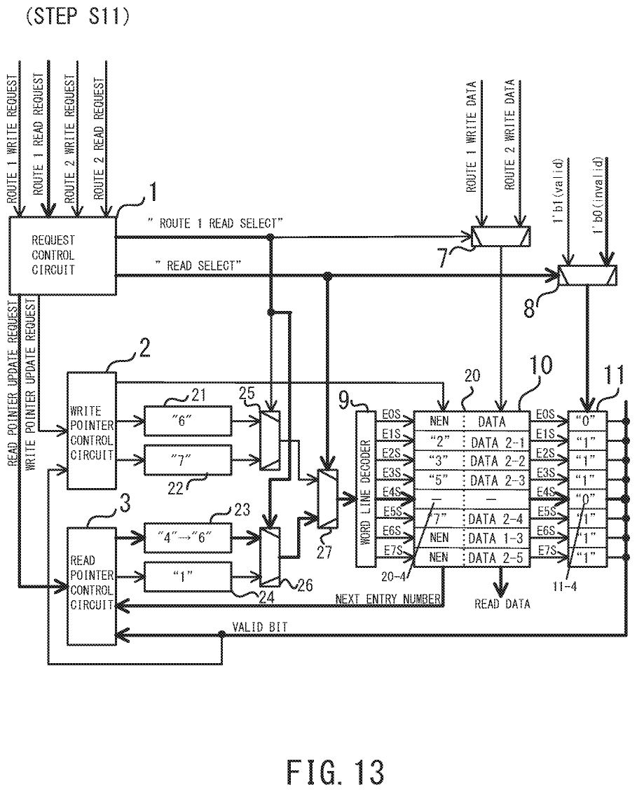

As illustrated in FIG. 13, for the second. read operation at the route 1, the request control circuit 1 receives a route 1 read request and transmits a read pointer update request to the read pointer control circuit 3.

Based on the read pointer update request of the request control circuit 1 the read pointer control circuit 3 updates the data held by the read pointer 23 from “4” to “6”. The read pointer selection circuit 26 receives a route 1 read select instruction outputted from the request control circuit 1. Based on the route 1 read select instruction from the request control circuit 1, the read pointer selection circuit 26 selects “4” of the read pointer 23. The selection circuit 27 receives a read select instruction outputted from the request control circuit 1. Based on the read select instruction from the request control circuit 1, the selection circuit 27 selects the selection result (“4”) from the read pointer selection circuit 26.

According to the value in the read pointer 23, the data (DATA 1-2) stored in the data memory area DATA of the buffer 20-4 is read and outputted to the outside. The data in the next-entry-number memory area NEN of the buffer 20-4 is read and transmitted to the read pointer control circuit 3. The data stored in the data memory area DATA of the buffer 20-4 and the data in the next-entry-number memory area NEN of the buffer 20-4 are updated. The validity bit 11-4 is changed from the valid information “1” to invalid information “0”, and the data is cleared. Information indicative of the clearing concerning the validity bit 11-4 is transmitted to the read pointer control circuit 3 (Step S11).

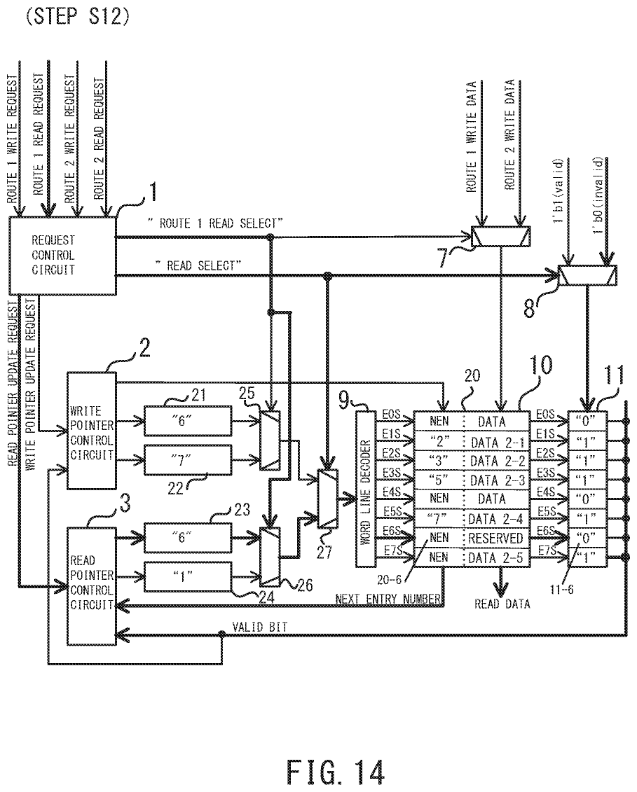

As illustrated in FIG. 14, for the third read operation at the route 1, the request control circuit 1 receives a route 1 read request.

The read pointer selection circuit 26 receives a route 1 read select instruction outputted from the request control circuit 1. Based on the route 1 read select instruction from the request control circuit 1., the read pointer selection circuit 26 selects “6” of the read pointer 23. The selection circuit 27 receives a read select instruction outputted from the request control. circuit 1. Based on the read select instruction from the request control circuit 1, the selection circuit 27 selects the selection result (“6”) from the read pointer selection circuit 26.

According to the value in the read pointer 23, the data (DATA 1-3) stored in the data memory area DATA of the buffer 20-6 is read and outputted to the outside. The data in the next-entry-number memory area NEN of the buffer 20-6 is read and transmitted to the read pointer control circuit 3. The data memory area DATA of the buffer 20-6 is set to the reserved state. The next-entry-number memory area NEN of the buffer 20-6 is available for the next entry. The validity bit 11-6 is changed from the valid information “1” to invalid information “0”, and the data is cleared. Information indicative of the clearing concerning the validity bit 11-6 is transmitted to the read pointer control circuit 3 (Step S12).

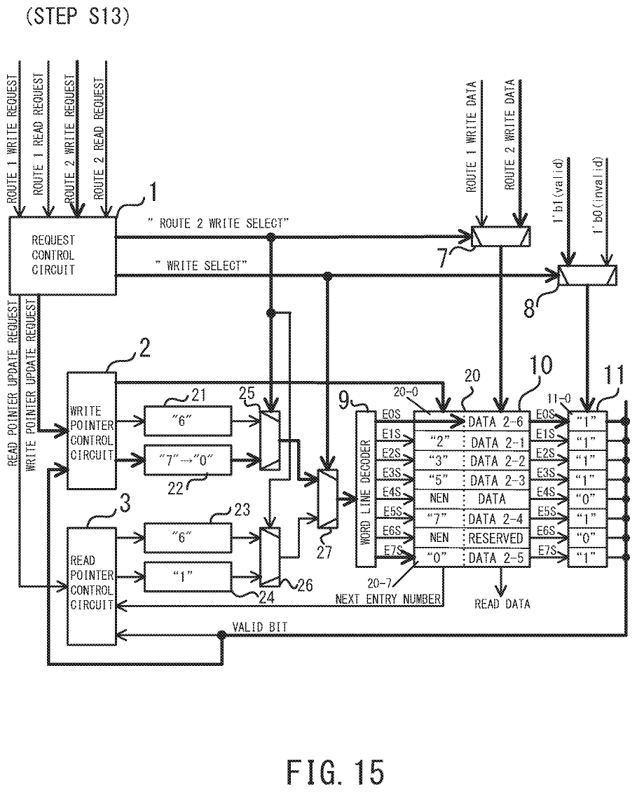

As illustrated in FIG. 15, for the sixth write operation at the route 2, the request control circuit 1 receives a route 2 write request and transmits a write pointer update request to the write pointer control circuit 2.

Based on the write pointer update request from the request control circuit 1, the write pointer control circuit 2 updates the data held by the write pointer 22 from “7” to “0”. The write pointer selection circuit 25 receives a route 2 write select instruction outputted from the request control circuit 1. Based on the route 2 write select instruction from the request control circuit 1, the write pointer selection circuit 25 selects “0” of the write pointer 22. The selection circuit 27 receives a write select instruction outputted from the request control circuit 1. Based on the write select instruction from the request control circuit 1, the selection circuit 27 selects the selection result (“0”) from the write pointer selection circuit 25.

The memory array 10 receives a decoding processing result from the word line decoder 9 and an instruction from the write pointer control circuit 2. As a result, the data in the next-entry-number memory area NEN of the buffer 20-7 is set to “0”. The data memory area DATA of the buffer 20-0 on the next word line is selected. Route 2 write data outputted from the data selection circuit 7 is written to the data memory area DATA of the buffer 20-0 (the data is indicated as DATA 2-6). Data in the validity bit 11-0 is set to valid information “1” based on 1′b1 outputted from the validity value selection circuit 8 and the write result from the data memory area DATA of the buffer 20-0. The valid information is transmitted to the write pointer control circuit 2 (Step S13).

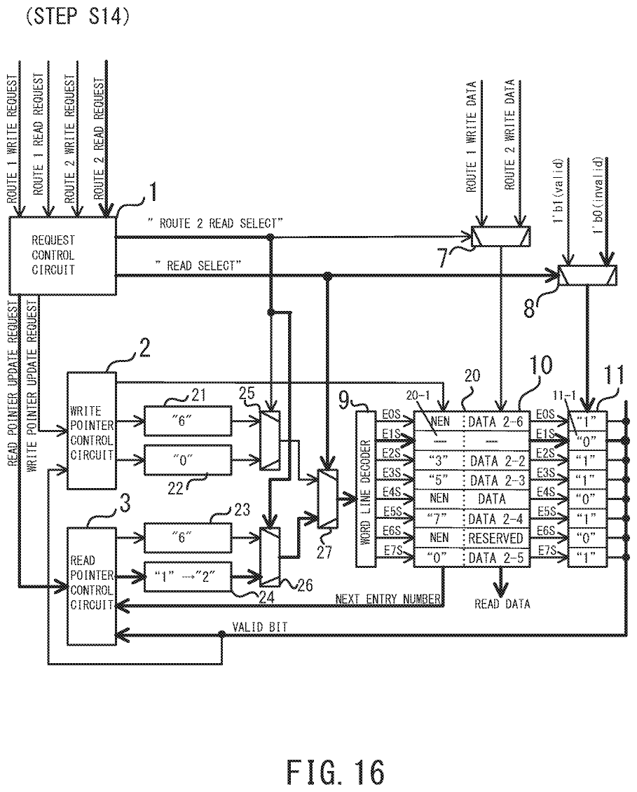

As illustrated in FIG. 16, for the first read operation at the route 2, the request control circuit 1 receives a route 2 read request and transmits a read pointer update request to the read pointer control circuit 3.

Based on the read pointer update request from the request control circuit 1, the read pointer control circuit 3 updates the data held by the read pointer 24 from “1” to “2”. The read pointer selection circuit 26 receives a route 2 read select instruction outputted from the request control circuit 1. Based on the route 2 read select instruction from the request control circuit 1, the read pointer selection circuit 26 selects “1” of the read pointer 24. The selection circuit 27 receives a read select instruction outputted from the request control circuit 1. Based on the read select instruction from the request control circuit 1, the selection circuit 27 selects the selection result (“1”) from the read pointer selection circuit 26.

According to the value in the read pointer 24, the data (DATA 2-1) stored in the data memory area DATA of the buffer 20-1 is read and outputted to the outside. The data in the next-entry-number memory area NEN of the buffer 20-1 is read and transmitted to the read pointer control circuit 3. The data stored in the data memory area DATA of the buffer 20-1 and the data in the next-entry-number memory area NEN of the buffer 20-1 are updated. The validity bit 11-1 is changed from the valid information “1” to invalid information “0”, and the data is cleared. Information indicative of the clearing concerning the validity bit 11-1 is transmitted to the read pointer control circuit 3 (Step S14).

Although the shared FIFO device 100 of the first embodiment includes two data transfer routes, the invention is not necessarily limited to such a case. The shared FIFO device may be provided with n transfer routes (where ii is an integer of 2 or greater). In such a case, the request control circuit receives n write requests and ii read requests. it is preferable that n write pointers and n read pointers are provided. it is also preferable that n pieces of write data are inputted to the data selection circuit 7.

As described above, the shared FIFO device 100 of the first embodiment is provided with the request control circuit 1, the write pointer control circuit 2, the read pointer control circuit 3, the data selection circuit 7, the validity value selection circuit 8, the word line decoder 9, the memory array 10, the validity bit section 11, the write pointer 21, the write pointer 22, the read pointer 23, the read pointer 24, the write pointer selection circuit 25, the read pointer selection circuit 26, and the selection circuit 27. The write pointer selection circuit 25 selects either data held by the write pointer 21 or data held by the write pointer 22 based on an instruction from the request control circuit 1. The read pointer selection circuit 26 selects either data held by the read pointer 23 or data held by the read pointer 24 based on an instruction from the request control circuit 1. The selection circuit 27 selects either a selection result from the write pointer selection circuit 25 or a selection result from the read pointer selection circuit 26 based on an instruction from the request control circuit 1.

Thus, the shared FIFO device 100 can use a plurality of data transfer routes in a shared manner simultaneously. As a result, the circuit scale of the shared FIFO device 100 can be reduced. Further, unused memory in the shared FIFO device 100 can be put into effective use.

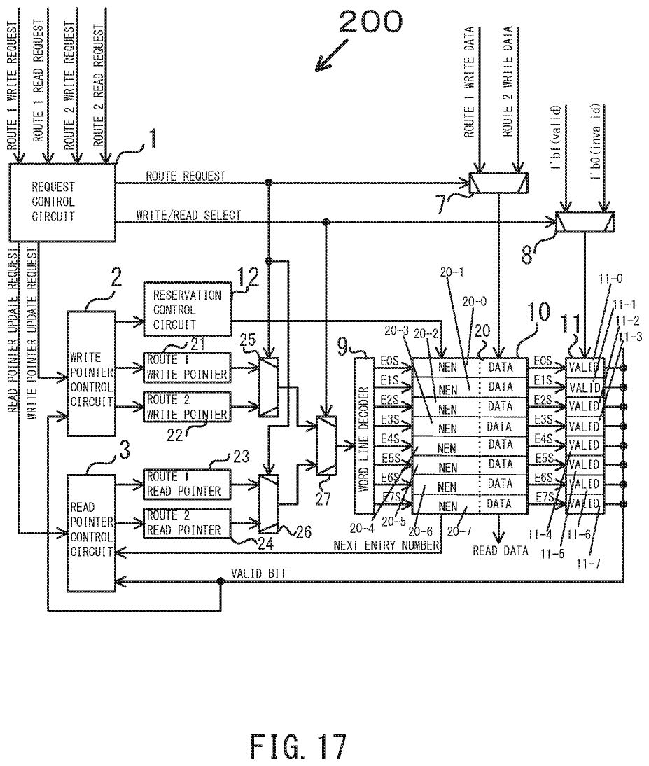

A shared FIFO device according to a second embodiment is described with reference to some of the drawings. FIG. 17 is a diagram illustrating the shared FIFO device.

The shared FIFO device of the second embodiment includes a reservation control circuit, two write pointers, two read pointers, a write pointer selection circuit, a read pointer selection circuit, and a selection circuit to select a write or read operation. To reduce circuit scale, two data transfer routes are provided, and reservation of the next entry is performed at the same time as a data write operation.

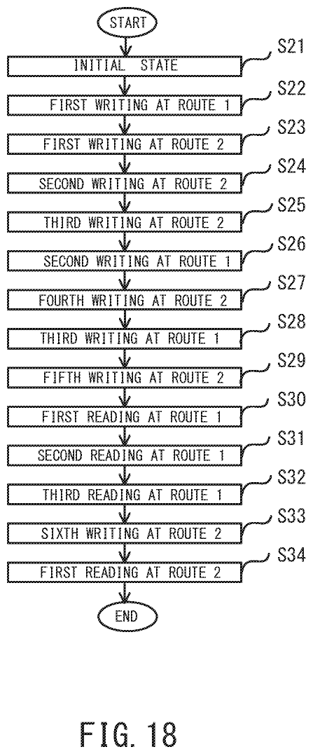

As illustrated in FIG. 18, a shared FIFO device 200 includes the request control circuit 1, the write pointer control circuit 2, the read pointer control circuit 3, the data selection circuit 7, the validity value selection circuit 8, the word line decoder 9, the memory array 10, the validity bit section 11, a reservation control circuit 12, the write pointer 21, the write pointer 22, the read pointer 23, the read pointer 24, the write pointer selection circuit 25, the read pointer selection circuit 26, and the selection circuit 27.

The shared FIFO device 200 of the second embodiment is the shared. FIFO device 100 of the first embodiment additionally including the reservation control circuit 12.

The same portions as those in the first embodiment are denoted by the same reference signs and are not described below. Only differences will be described.

The reservation control circuit 12 determines the entry number for the next write operation based on the value in the write pointer 21, the value in the write pointer 22, and the value in the validity bit section 11, and outputs the number of the entry where the next data is to be stored (entry link information) to the next-entry-number memory area NEN of the memory array 10.

In the first embodiment, the data memory area DATA and the next-entry-number memory area NEN of different entries need to be accessed in a write operation. For this reason, the first embodiment needs to access them independently or access them in two cycles.

In contrast, the shared FIFO device 200 of the second embodiment performs processing to write the entry number where the next data is to be written at the same time as a data write operation.

In the second embodiment, the values in the write pointer 21 and the write pointer 22 are updated after write access is made to the buffers 20, and the values in the read pointer 23 and the read pointer 24 are updated after read access is made to the buffers 20. Write access and read access to the buffers 20-0 to 20-7 are performed using pre-update pointer values.

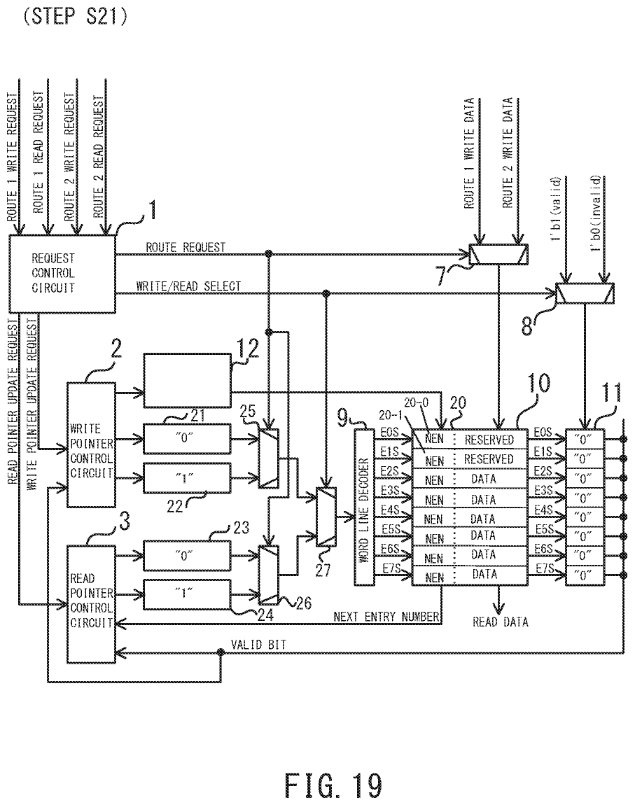

Next, operation of the shared. FIFO device is described with reference to FIGS. 18 to 32. FIG. 18 is a flowchart illustrating the operation of the shared FIFO device. FIGS. 19 to 32 are diagrams illustrating the steps of the operation of the shared FIFO device,

As illustrated in FIG. 19, in the initial state, the reservation control circuit 12 has not received an instruction from the write pointer control circuit 2. Data in the write pointer 21 is set to “0”, data in the write pointer 22 is set to “1”, data in the read pointer 23 is set to “0”, and data in the read pointer 24 is set to “1”. The data memory area DATA of the buffer 20-0 and the data memory area DATA of the buffer 20-1 are set to the reserved state (Step S21).

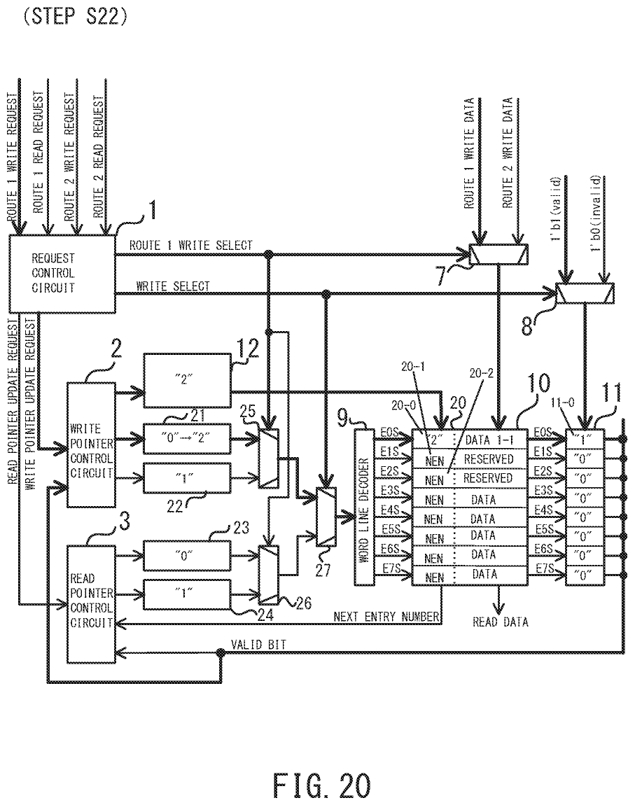

As illustrated in FIG. 20, for the first write operation at the route 1, the request control circuit 1 receives a route 1 write request. The write pointer control circuit 2 receives a write pointer update request outputted from the request control circuit 1. The reservation control circuit 12 stores “2” which is reservation information transmitted from the write pointer control circuit 2. Based on the write pointer update request from the request control circuit 1, the write pointer control circuit 2 updates the information in the write pointer 21 from “0” to “2”.

The write pointer selection circuit 25 receives a route 1 write select instruction outputted from the request control circuit 1. Based on the route write select instruction from the request control circuit 1, the write pointer selection circuit 25 selects “0” which is the value in the write pointer 21. The selection circuit 27 receives a write select instruction outputted from the request control circuit 1. Based on the write select instruction from the request control circuit 1, the selection circuit 2 a selects the selection result (“0”) from the write pointer selection circuit 25.

The memory array 10 receives the information “2” outputted from the reservation control circuit 12 and a decoding processing result from the word line decoder 9.

As a result, the information “2” in the reservation control circuit 12 is written to the next-entry-number memory area NEN of the buffer 20-0, and the data memory area DATA of the buffer 20-2 is set to the reserved state. Route 1 write data outputted from the data selection circuit 7 is written to the data memory area DATA of the buffer 20-0 (the data is indicated as DATA 1-1). Data in the validity bit 11-0 is set to valid information “1” based on 1′b1 outputted from the validity value selection circuit 8 and the write result from the data memory area DATA of the buffer 20-0. The valid information is transmitted to the write pointer control circuit 2 (Step S22).

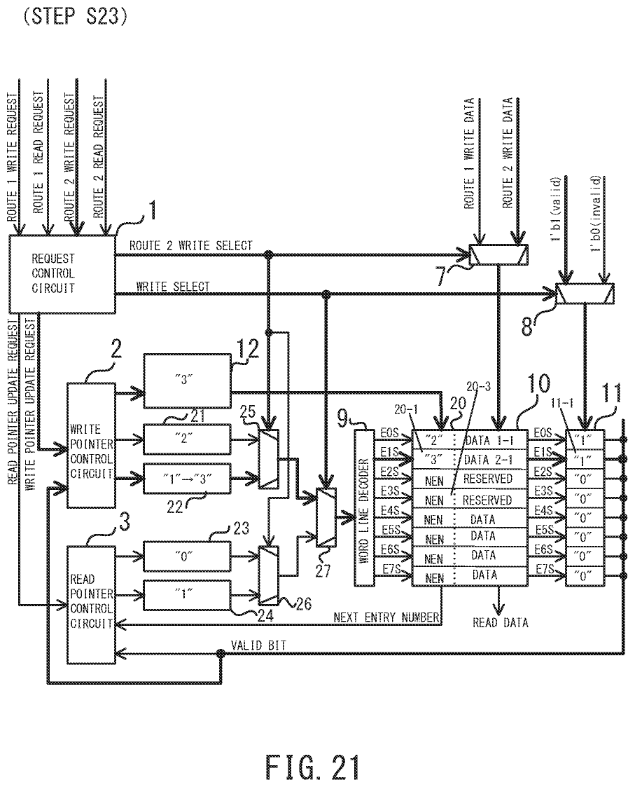

As illustrated in FIG. 21, for the first write operation at the route 2, the request control circuit 1 receives a route 2 write request. The write pointer control circuit 2 receives a write pointer update request outputted from the request control circuit 1. The reservation control circuit 12 stores reservation information “3” transmitted from the write pointer control circuit 2. Based on the write pointer update request from the request control circuit 1, the write pointer control circuit 2 updates the value held by the write pointer 22 from “1” to “3”. The write pointer selection circuit 25 receives a route 2 write select instruction outputted from the request control circuit 1. Based on the route 2 write select instruction from the request control circuit 1, the write pointer selection circuit 25 selects “1” of the write pointer 22.

The selection circuit 27 receives a write select instruction outputted from the request control circuit 1. Based on the write select instruction. from the request control circuit 1, the selection circuit 27 selects the selection. result (“1”) from the write pointer selection circuit 25.

The memory array 10 receives the information “3” outputted from the reservation control circuit 12 and a decoding processing result from the word line decoder 9.

As a result, the information “3” in the reservation control circuit 12 is written to the next-entry-number memory area NEN of the buffer 20-1, and the data memory area DATA of the buffer 20-3 is set to the reserved state. Route 2 write data outputted from the data selection circuit 7 is written to the data memory area DATA of the buffer 20-1 (the data is indicated as DATA 2-1). Data in the validity bit 11-1 is set to valid information “1” based 1′b1 outputted from the validity value selection circuit 8 and the write result from the data memory area DATA of the buffer 20-1. The valid information is transmitted to the write pointer control circuit 2 (Step S23).

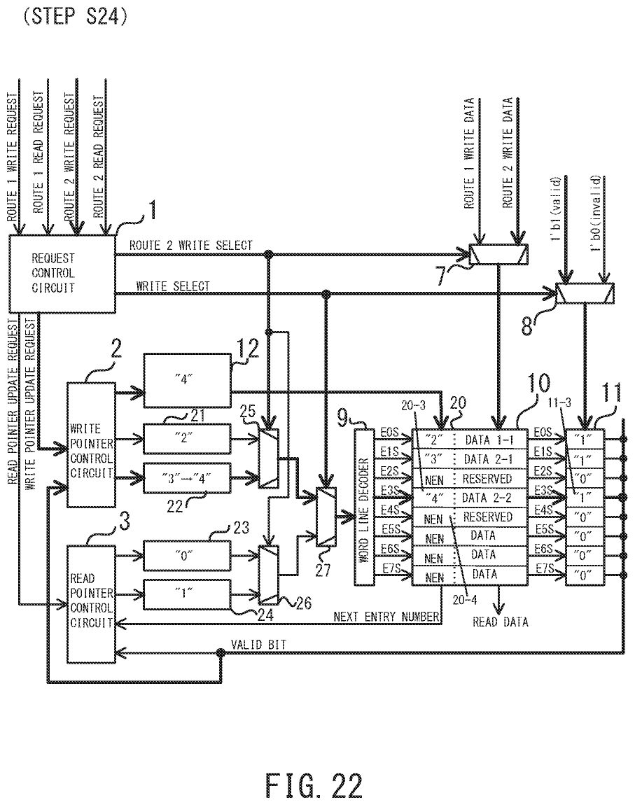

As illustrated in FIG. 22, for the second write operation at the route 2, the request control circuit 1 receives a route 2 write request and transmits a write pointer update request to the write pointer control circuit 2. The reservation control circuit 12 stores reservation information “4” transmitted from the write pointer control circuit 2. Based on the write pointer update request from the request control circuit 1, the write pointer control circuit 2 updates the value held by the write pointer 22 from “3” to “4”.

The write pointer selection circuit 25 receives a route 2 write select instruction outputted from the request control circuit 1. Based on the route 2 write select instruction from the request control circuit 1, the write pointer selection circuit 25 selects “3” of the write pointer 22. The selection circuit 27 receives a write select instruction outputted from the request control. circuit 1. Based on the write select instruction from the request control. circuit 1, the selection circuit 27 selects the selection result (“3”) from the write pointer selection circuit 25.

The memory array 10 receives the information “4” outputted from the reservation control circuit 12 and a decoding processing result from the word line decoder 9.

As a result, the information “4” in the reservation control circuit 12 is written to the next-entry-number memory area NEN of the buffer 20-3, and the data memory area DATA of the buffer 20-4 is set to the reserved state. Route 2 write data outputted from the data selection circuit 7 is written to the data memory area DATA of the buffer 20-3 (the data is indicated as DATA 2-2). Data in the validity bit 11-3 is set to valid information “1” based on 1′b1 outputted from the validity value selection circuit 8 and the write result from the data memory area DATA of the buffer 20-3. The valid information is transmitted to the write pointer control circuit 2 (Step S24).

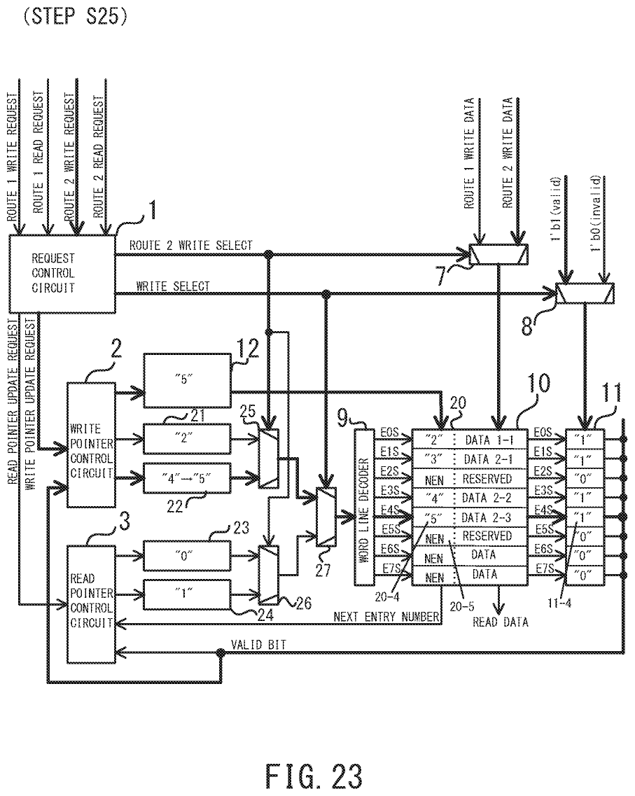

As illustrated in FIG. 23, for the third write operation at the route 2, the request control circuit 1 receives a route 2 write request and transmits a write pointer update request to the write pointer control circuit 2. The reservation control circuit 12 stores reservation information “5” transmitted from the write pointer control circuit 2. Based on the write pointer update request from the request control circuit 1, the write pointer control circuit 2 updates the value held by the write pointer 22 from “4” to “5”.

The write pointer selection circuit 25 receives a route 2 write select instruction outputted from the request control circuit 1. Based on the route 2 write select instruction from the request control circuit 1, the write pointer selection circuit 25 selects “4” of the write pointer 22. The selection circuit 27 receives a write select instruction outputted from the request control. circuit 1. Based on the write select instruction from the request control. circuit 1, the selection circuit 27 selects the selection result (“4”) from the write pointer selection circuit 25.

The memory array 10 receives the information “5” outputted from the reservation control circuit 12 and a decoding processing result from the word line decoder 9.

As a result, the information “5” in the reservation control circuit 12 is written to the next-entry-number memory area NEN of the buffer 20-4, and the data memory area DATA of the buffer 20-5 is set to the reserved state. Route 2 write data outputted from the data selection circuit 7 is written to the data memory area DATA of the buffer 20-4 (the data is indicated as DATA 2-3). Data in the validity bit 11-4 is set to valid information “1” based on 1%1 outputted from the validity value selection circuit 8 and the write result from the data memory area DATA of the buffer 20-4. The valid information is transmitted to the write pointer control circuit 2 (Step S25).

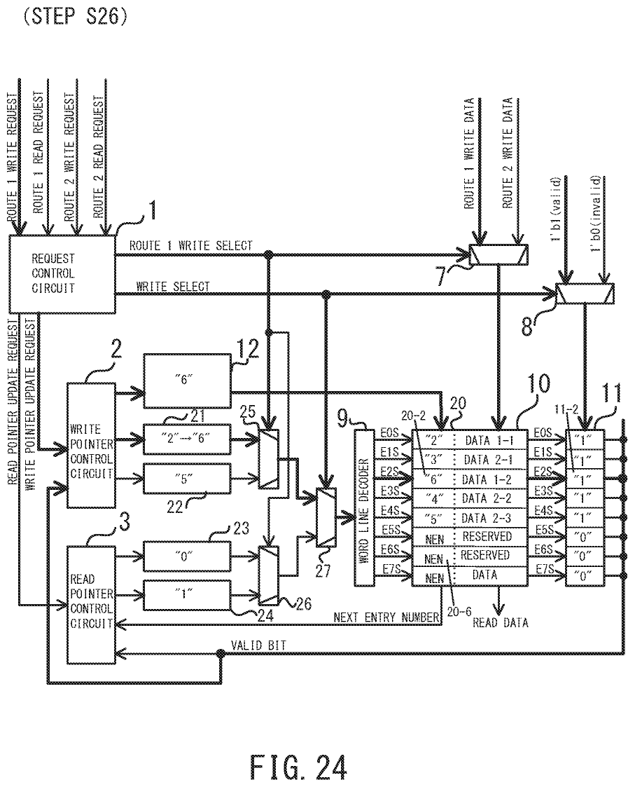

As illustrated in FIG. 24, for the second write operation at the route 1, the request control circuit 1 receives a route 1 write request and transmits a write pointer update request to the write pointer control circuit 2. The reservation control circuit 12 stores reservation information “6” transmitted from the write pointer control circuit 2.

Based on the write pointer update request from the request control circuit 1, the write pointer control circuit 2 updates the data held by the write pointer 21 from “2” to “6”. The write pointer selection circuit 25 receives a route 1 write select instruction outputted from the request control circuit 1. Based on the route 1 write select instruction from the request control circuit 1, the write pointer selection circuit 25 selects “2” of the write pointer 21. The selection circuit 27 receives a write select instruction. outputted from the request control circuit 1. Based on the write select instruction from the request control circuit 1, the selection circuit 27 selects the selection result (“2”) from the write pointer selection circuit 25.

The memory array 10 receives the information “6” outputted from the reservation control circuit 12 and a decoding processing result from the word line decoder 9.

As a result, the information “6” in the reservation control circuit 12 is written to the next-entry-number memory area NEN of the buffer 20-2, and the data memory area DATA of the buffer 20-6 is set to the reserved state, Route 1 write data outputted from the data selection circuit 7 is written to the data memory area DATA of the buffer 20-2 (the data is indicated as DATA 1-2). Data in the validity bit 11-2 is set to valid information “1” based on Pin outputted from the validity value selection circuit 8 and the write result from the data memory area DATA of the buffer 20-2. The valid information is transmitted to the write pointer control circuit 2 (Step S26).

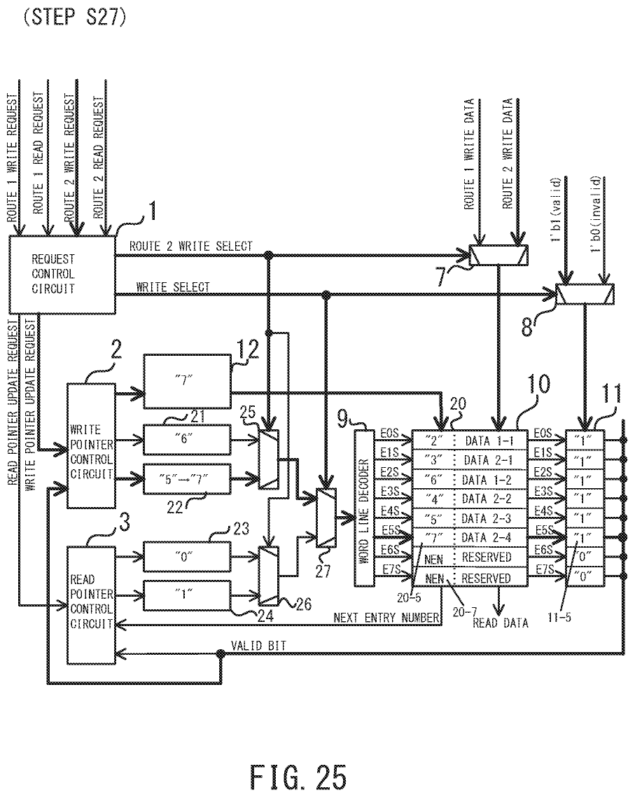

As illustrated in FIG. 25, for the fourth write operation at the route 2, the request control circuit 1 receives a route 2 write request and transmits a write pointer update request to the write pointer control circuit 2. The reservation control circuit 12 stores reservation information “7” transmitted from the write pointer control circuit 2.

Based on the write pointer update request from the request control circuit 1, the write pointer control circuit 2 updates the data held by the write pointer 22 from “5” to “7”. The write pointer selection circuit 25 receives a route 2 write select instruction outputted from the request control. circuit 1. Based on the route 2 write select instruction from the request control circuit 1, the write pointer selection circuit 25 selects “5” of the write pointer 22. The selection circuit 27 receives a write select instruction outputted from the request control circuit 1. Based on the write select instruction from the request control circuit 1, the selection circuit 27 selects the selection result (“5”) from the write pointer selection circuit 25.

The memory array 10 receives the information “7” outputted from the reservation control circuit 12 and a decoding processing result from the word line decoder 9.

As a result, the information “7” in the reservation control circuit 12 is written to the next-entry-number memory area NEN of the buffer 20-5, and the data memory area DATA of the buffer 20-7 is set to the reserved state, Route 2 write data outputted from the data selection circuit 7 is written to the data memory area DATA of the buffer 20-5 (the data is indicated as DATA 2-4). Data in the validity bit 11-5 is set to valid information “1” based on 1%1 outputted from the validity value selection circuit 8 and the write result from the data memory area DATA of the buffer 20-5. The valid information is transmitted to the write pointer control circuit 2 (Step S27).

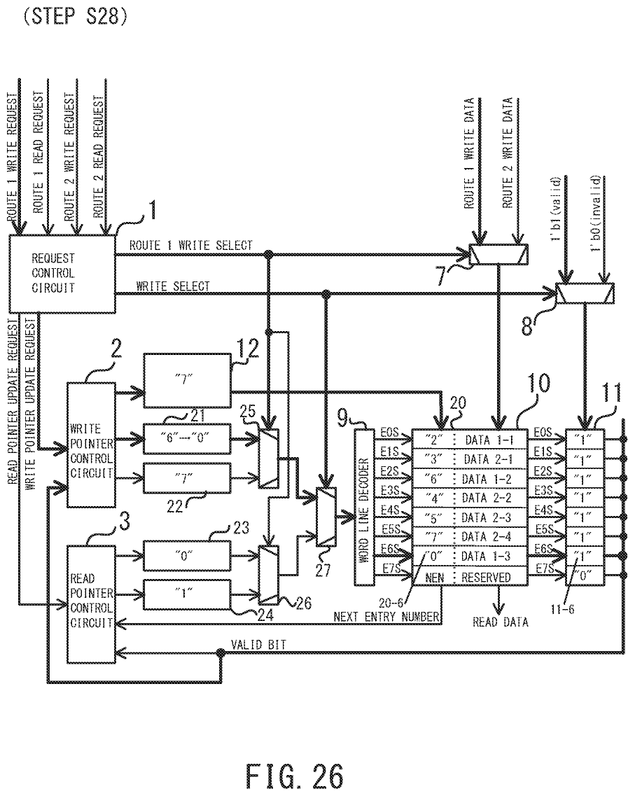

As illustrated in FIG. 26, for the third write operation at the route 1, the request control circuit 1 receives a route 1 write request and transmits a write pointer update request to the write pointer control circuit 2. The reservation control circuit 12 maintains the reservation information “7” transmitted from the write pointer control circuit 2.

Based on the write pointer update request from the request control circuit 1, the write pointer control circuit 2 updates the data held by the write pointer 21 from “6” to “0”. The write pointer selection circuit 25 receives a route 1 write select instruction outputted from the request control. circuit 1. Based on the route 1 write select instruction from the request control circuit 1, the write pointer selection circuit 25 selects “0” of the write pointer 21. The selection circuit 27 receives a write select instruction. outputted from the request control circuit 1. Based on the write select instruction from the request control circuit 1, the selection circuit 27 selects the selection result (“0”) from the write pointer selection circuit 25.

The memory array 10 receives the information “7” in the reservation control circuit 12 and a decoding processing result from the word line decoder 9.

As a result, the information “0” in the write pointer 21 is written to the next-entry-number memory area NEN of the buffer 20-6. Route 1 write data outputted from the data selection circuit 7 is written to the data memory area DATA of the buffer 20-6 (the data is indicated as DATA 1-3). Data in the validity bit 11-6 is set to valid information “1” based on 1′b1 outputted from the validity value selection circuit 8 and the write result from the data memory area DATA of the buffer 20-6. The valid information is transmitted to the write pointer control circuit 2 (Step S28).

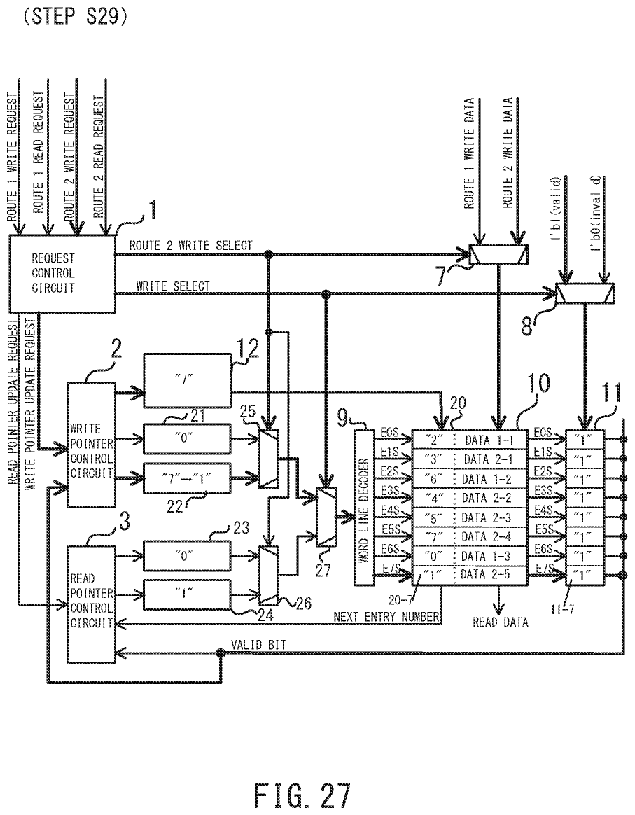

As illustrated in FIG. 27, for the fifth write operation at the route 2, the request control circuit 1 receives a route 2 write request and transmits a write pointer update request to the write pointer control circuit 2. The reservation control circuit 12 maintains reservation information “7” transmitted from the write pointer control circuit 2.

Based on the write pointer update request from the request control circuit 1, the write pointer control circuit 2 updates the data held by the write pointer 22 from “7” to “1”. The write pointer selection circuit 25 receives a route 2 write select instruction outputted from the request control. circuit 1. Based on the route 2 write select instruction from the request control circuit 1, the write pointer selection circuit 25 selects “1” of the write pointer 22. The selection circuit 27 receives a write select instruction. outputted from the request control circuit 1. Based on the write select instruction from the request control circuit 1, the selection circuit 27 selects the selection result (“1”) from the write pointer selection circuit 25.

The memory array 10 receives the information “7” outputted from the reservation control circuit 12 and a decoding processing result from the word line decoder 9.

As a result, the information “1” in the write pointer 22 is written to the next-entry-number memory area NEN of the buffer 20-7. Route 2 write data outputted from the data selection circuit 7 is written to the data memory area DATA of the buffer 20-7 (the data is indicated as DATA 2-5). Data in the validity bit 11-7 is set to valid information “1” based on 1′b1 outputted from the validity value selection circuit 8 and the write result from the data memory area DATA of the buffer 20-7. The valid information is transmitted to the write pointer control circuit 2 (Step S29).

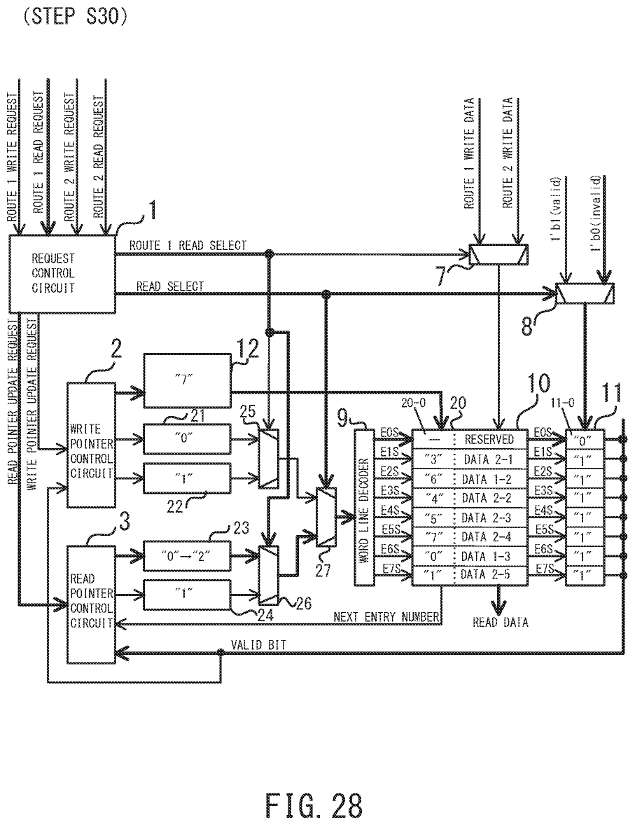

As illustrated in FIG. 28, for the first read operation at the route 1, the request control circuit 1 receives a route 1 read request and transmits a read pointer update request to the read pointer control circuit 3. The reservation control circuit 12 maintains reservation information “7” transmitted from the write pointer control circuit 2.

Based on the read pointer update request from the request control circuit 1, the read pointer control circuit 3 updates the data held by the read pointer 23 from “0” to “2”. The read pointer selection circuit 26 receives a route 1 read select instruction outputted from the request control circuit 1. Based on the route 1 read select instruction from the request control circuit 1, the read pointer selection circuit 26 selects “0” of the read pointer 23. The selection circuit 27 receives a read select instruction outputted from the request control circuit 1. Based on the read select instruction from the request control circuit 1, the selection circuit 27 selects the selection result (“0”) from the read pointer selection circuit 26.

According to the value in the read pointer 23, the data (DATA 1-1) stored in the data memory area DATA of the buffer 20-0 is read and outputted to the outside. The data in the next-entry-number memory area NEN of the buffer 20-0 is read and transmitted to the read pointer control circuit 3. The data stored in the data memory area DATA of the buffer 20-0 and the data in the next-entry-number memory area NEN of the buffer 20-0 are updated. The validity bit 11-0 is changed from the valid information “1” to invalid information “0”, and the data is cleared. Information indicative of the clearing concerning the validity bit 11-0 is transmitted to the read pointer control circuit 3 (Step S30).

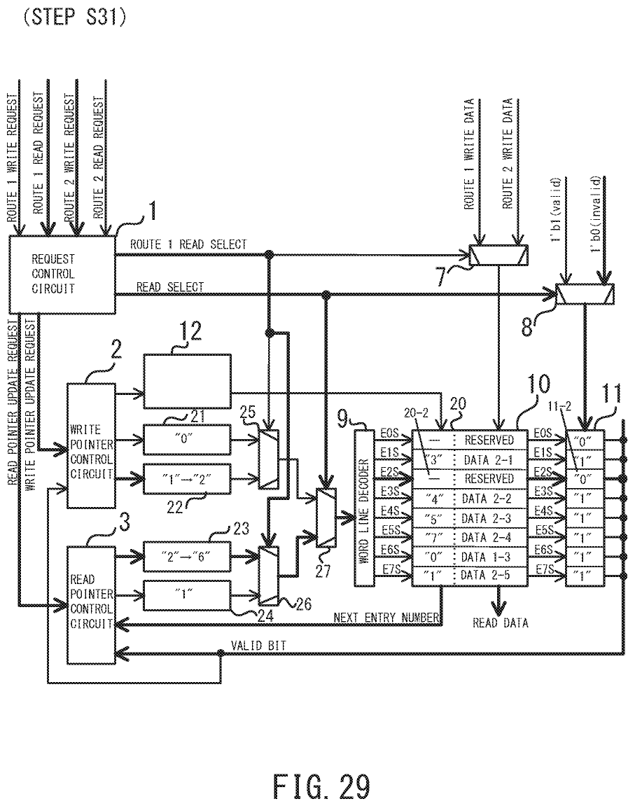

As illustrated in FIG. 29, for the second read operation at the route 1, the request control circuit 1 receives a route 1 read request and transmits a read pointer update request to the read pointer control circuit 3. The reservation control circuit 12 does not hold any reservation information transmitted from the write pointer control circuit 2.

The read pointer selection circuit 26 receives a route 1 read select instruction outputted from the request control circuit 1. Based on the route 1 read select instruction from the request control circuit 1, the read pointer selection circuit 26 updates the data held by the read pointer 23 from “2” to “6”. The selection circuit 27 receives a read select instruction outputted from the request control circuit 1. Based on the read select instruction from the request control circuit 1, the selection circuit 27 selects the selection. result (“2”) from the read pointer selection circuit 26.

According to the value in the read pointer 23, the data (DATA 1-2) stored in the data memory area DATA of the buffer 20-2 is read and outputted to the outside. The data in the next-entry-number memory area NEN of the buffer 20-2 is read and transmitted to the read pointer control circuit 3. The data stored in the data memory area DATA of the buffer 20-2 and the data in the next-entry-number memory area NEN of the buffer 20-2 are updated. The validity bit 11-2 is changed from the valid information “1” to invalid information “0”, and the data is cleared. Information indicative of the clearing concerning the validity bit 11-2 is transmitted. to the read pointer control circuit 3 (Step S31).

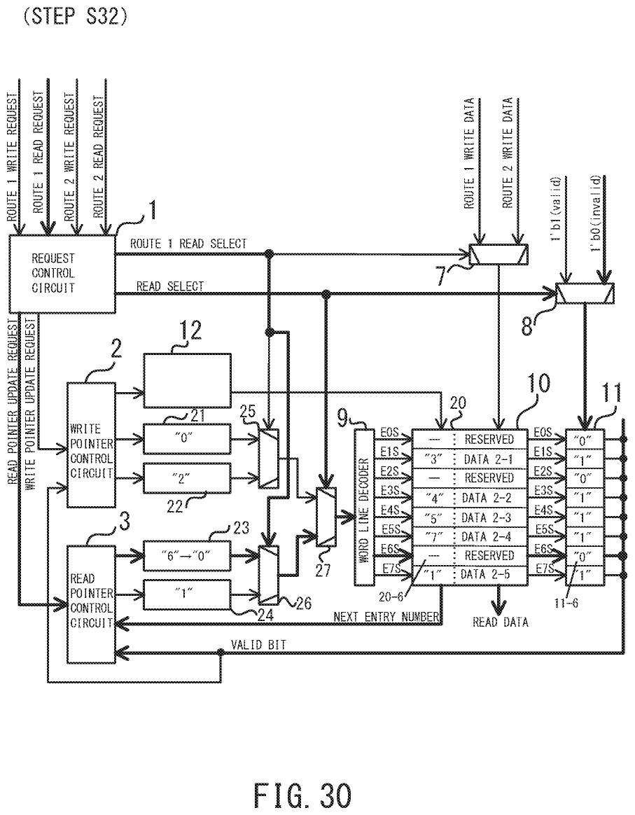

As illustrated in FIG. 30, for the third read operation at the route 1, the request control circuit 1 receives a route 1 read request and transmits a read pointer update request to the read pointer control circuit 3. The reservation control circuit 12 does not hold any reservation information transmitted from the write pointer control circuit 2.

The read pointer selection circuit 26 receives a route 1 read select instruction outputted from the request control circuit 1. Based on the route 1 read select instruction from the request control circuit 1, the read pointer selection circuit 26 updates the data held by the read pointer 23 from “6” to “0”. The selection circuit 27 receives a read select instruction outputted from the request control circuit 1. Based on the read select instruction from the request control circuit 1, the selection circuit 27 selects the selection. result (“6”) from the read pointer selection circuit 26.

According to the value in the read pointer 23, the data (DATA 1-3) stored in the data memory area DATA of the buffer 20-6 is read and outputted to the outside. The data in the next-entry-number memory area NEN of the buffer 20-6 is read and transmitted to the read pointer control. circuit 3. The data stored in the data memory area DATA of the buffer 20-6 and the data in the next-entry-number memory area NEN of the buffer 20-6 are updated. The validity bit 11-6 is changed from the valid information “1” to invalid information “0”, and the data is cleared. Information indicative of the clearing concerning the validity bit 11-6 is transmitted to the read pointer control circuit 3 (Step S32).

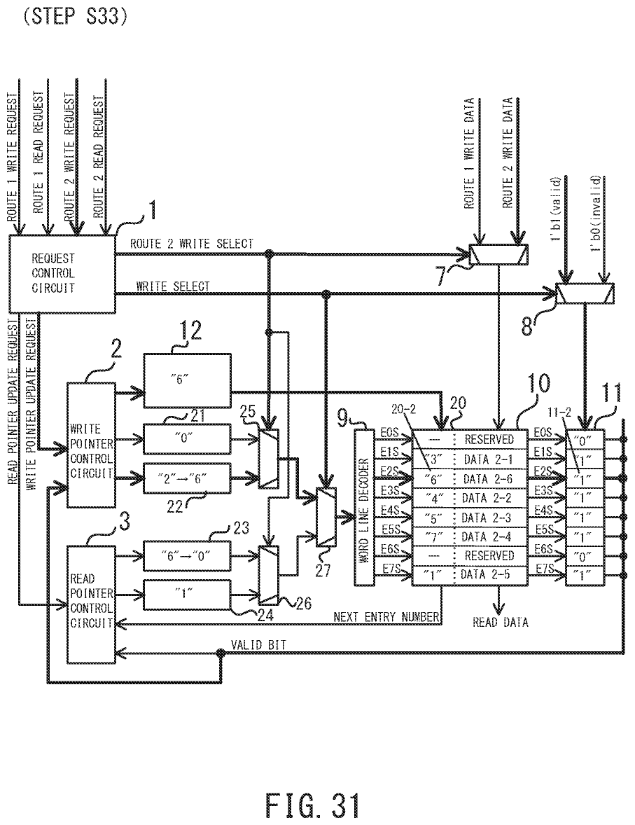

As illustrated in FIG. 31, for the sixth write operation at the route 2, the request control circuit 1 receives a route 2 write request and transmits a write pointer update request to the write pointer control circuit 2. The reservation control circuit 12 stores reservation information “6” transmitted from the write pointer control circuit 2.

Based on the write pointer update request from the request control circuit 1, the write pointer control circuit 2 updates the data held by the write pointer 22 from “2” to “6”. The write pointer selection circuit 25 receives a route 2 write select instruction outputted from the request control circuit 1. Based on the route 2 write select instruction from the request control circuit 1, the write pointer selection circuit 25 selects “2” of the write pointer 22. The selection circuit 27 receives a write select instruction outputted from the request control circuit 1. Based on the write select instruction from the request control circuit 1, the selection circuit 27 selects the selection result (“2”) from the write pointer selection circuit 25.

The memory array 10 receives the information “6” outputted from the reservation control circuit 12 and a decoding processing result from the word line decoder 9.

As a result, the information “6” is written to the next-entry-number memory area NEN of the buffer 20-2. Route 2 write data outputted from the data selection circuit 7 is written to the data memory area DATA of the buffer 20-2 (the data is indicated as DATA 2-6). Data in the validity bit 11-2 is set to valid information “1” based on 1′b1 outputted from the validity value selection circuit 8 and the write result from the data memory area DATA of the buffer 20-2. The valid information is transmitted to the write pointer control circuit 2 (Step S33).

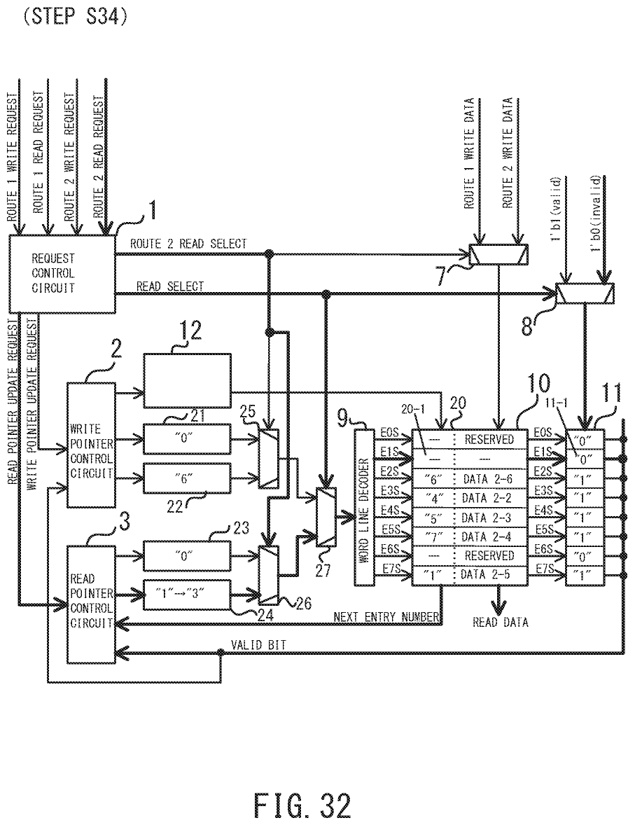

As illustrated in FIG. 32, for the first read operation at the route 2, the request control circuit 1 receives a route 2 read request and transmits a read pointer update request to the read pointer control circuit 3. The reservation control circuit 12 does not hold any reservation information transmitted from the write pointer control circuit 2.

Based on the read pointer update request from the request control circuit 1, the read pointer control circuit 3 updates the data held by the read pointer 24 from “1” to “3”. The read pointer selection circuit 26 receives a route 2 read select instruction outputted from the request control circuit 1. Based on the route 2 read select instruction from the request control circuit 1, the read pointer selection circuit 26 selects “1” of the read pointer 24. The selection circuit 27 receives a read select instruction outputted from the request control circuit 1. Based on the read select instruction from the request control circuit 1, the selection circuit 27 selects the selection result (“1”) from the read pointer selection circuit 26.

According to the value in the read pointer 24, the data (DATA 2-1) stored in the data memory area DATA of the buffer 20-1 is read and outputted to the outside. The data in the next-entry-number memory area NEN of the buffer 20-1 is read and transmitted to the read pointer control circuit 3. The data stored in the data memory area DATA of the buffer 20-1 and the data in the next-entry-number memory area NEN of the buffer 20-1 are updated. The validity bit 11-1 is changed from the valid information “1” to invalid information “0”, and the data is cleared. Information indicative of the clearing concerning the validity bit 11-1 is transmitted to the read pointer control circuit 3 (Step S34).

As described above, the shared FIFO device 200 of the second embodiment is provided with the request control circuit 1, the write pointer control circuit 2, the read pointer control circuit 3, the data selection circuit 7, the validity value selection circuit 8, the word line decoder 9, the memory array 10, the validity bit section 11, the reservation control circuit 12, the write pointer 21, the write pointer 22, the read pointer 23, the read pointer 24, the write pointer selection circuit 25, the read pointer selection circuit 26, and the selection circuit 27. The reservation control circuit 12 determines the entry number for the next write operation based on the value in the write pointer 21, the value in the write pointer 22, and the value in the validity bit section 11, and outputs the number of the entry where the next data is to be stored to the next-entry-number memory area NEN of the memory array 10

Thus, in addition to the advantageous effects produced by the first embodiment, the shared FIFO device 200 can improve simplicity of the structure of the memory array 10 and access performance of the memory array 10.

While certain embodiments have been described, these embodiments have been presented by way of example only and are not intend to limit the scope of the inventions. Indeed, the novel embodiments described herein. may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A shared. FIFO device, comprising:
a write pointer control circuit configured to receive a write pointer update request, select one of n write pointers(where n is an integer of 2 or greater) based on the write pointer update request, the write pointers being arranged independently for the respective transfer routes, and instruct the selected write pointer to update information held by the write pointer;
a read pointer control circuit configured to receive a read pointer update request, select one of n read pointers based on the read pointer update request, the read pointers being arranged independently for the respective transfer routes, and instruct the selected read pointer to update information held by the read pointer;
a write pointer selection circuit configured to receive a route write select instruction, and select the information in one of the n write pointers based on the route write select instruction;
a read pointer selection circuit configured to receive a route read select instruction, and select the information in one of the n read pointers based on the route read select instruction;
a selection circuit configured to receive a write select instruction, select a selection result from the write pointer selection circuit based on the write select instruction, receive a read select instruction, and select a selection result from the read pointer selection circuit based on the read select instruction; and
a memory array having in FIFO buffer memories (where m is an integer of 2 or greater), each of the m FIFO buffer memories including a next-entry-number memory area and a data memory area to be accessed based on write pointer information and read pointer information, wherein the shared FIFO device performs FIFO access through n transfer routes.

2. The shared FIFO device according to claim 1, further comprising a request control circuit configured to receive a write request and a read request and generate the write pointer update request, the read pointer update request, the route write select instruction, the route read select instruction, the write select instruction, and the read select instruction.

3. The shared FIFO device according to claim 1, further comprising
a validity bit section, including in validity bits for respective entries of the memory array, configured to transmit update information to the write pointer control circuit or the read pointer control circuit when a value in any of the validity bits is updated.

4. The shared FIFO device according to claim 3, further comprising
a validity value selection circuit configured to update one of the validity bits in the validity bit section to a valid value based on the write select instruction outputted from the request control circuit, and update one of the validity bits in the validity bit section to an invalid value based on the read select instruction outputted from the request control circuit.

5. The shared FIFO device according to claim 3, further comprising
a data selection circuit configured to select one of n pieces of route write data based on the route write select instruction outputted from the request control circuit, and write the selected piece of route write data to one of the data memory areas of the memory array.

6. The shared FIFO device according to claim 1, further comprising
a reservation control circuit configured to generate an entry number where data is to be written at a next data write operation as instructed by the write pointer control circuit, and transmit the entry number to the memory array.

7. The shared FIFO device according to claim 1, further comprising
a word line decoder provided between the selection circuit and the memory array, wherein
the word line decoder receives a selection result from the selection circuit, performs decoding processing on the selection result, and transmits a result of the decoding processing to the memory array as an entry request.

8. The shared FIFO device according to claim 7, wherein
upon receipt of the result of the decoding processing from the word line decoder and an instruction from the write pointer control circuit, the memory array writes write data to the data memory area of a next word line.

9. The shared FIFO device according to claim 1, wherein
the write pointer selection circuit, the read pointer selection circuit, and the selection circuit are a multiplexer or a selector.

10. The shared FIFO device according to claim 1, wherein
the shared FIFO device is applied to a system including a microcomputer or a microprocessor and n synchronized data transfer routes.

11. The shared FIFO device according to claim 1, wherein
the shared FIFO device is applied to a wearable device, a healthcare device, an industrial safety device, or a humanoid robot.
